(19) United States
(12) Patent Application Publication
(10) Pub. No.: US 2025/0250783 A1
(43) Pub. Date: Aug. 7, 2025

(54) GREY WATER TANK AND GREY WATER SYSTEM

(71) Applicant: Diehl Aviation Gilching GmbH, Gilching (DE)

(72) Inventors: Bertram Skibinski, Markkleeberg (DE); Hannes Krenz, Dresden (DE); Jan Boris Philipp, München (DE)

(21) Appl. No.: 19/191,239

(22) Filed: Apr. 28, 2025

Related U.S. Application Data
(63) Continuation of application No. PCT/EP2023/080181, filed on Oct. 30, 2023.

(30) Foreign Application Priority Data
Nov. 2, 2022 (DE) 10 2022 128 992.3

(51) Int. Cl. E03B 1/04; C02F 1/00; C02F 103/00

(52) U.S. Cl. CPC E03B 1/042; C02F 1/001; C02F 2103/002; C02F 2201/001

(57) ABSTRACT

A grey water tank for vehicles. The grey water tank includes a tank housing having an interior for holding grey water, a filter wall inside the tank housing, an inner tank chamber provided inside the filter wall and an outer tank chamber being provided between the filter wall and the tank housing side wall. A fill level sensor is provided for detecting a fill level of the tank housing. A connection is provided on the tank housing cover in the region of the inner tank chamber for a grey water inlet from a washing device. A connection is provided on the tank housing for a grey water transfer line to a toilet requiring flushing liquid. In order to empty and clean the grey water tank, a connection for a waste water line for discharging the grey water present in the tank housing by a vacuum discharge system is also provided.

### CROSS-REFERENCE TO RELATED APPLICATION

This application is a continuation, under 35 U.S.C. § 120, of copending International Patent Application PCT/EP2023/080181, filed Oct. 30, 2023, which designated the United States; this application also claims the priority, under 35 U.S.C. § 119, of German Patent Application DE 10 2022 128 992.3, filed Nov. 2, 2022; the prior applications are herewith incorporated by reference in their entirety.

### FIELD AND BACKGROUND OF THE INVENTION

The present invention relates to a grey water tank and to a grey water system containing said tank, which are suitable for vehicles (in particular for aircraft).

Aircraft, ships, trains and also other vehicles generally have on-board toilets and washbasins (e.g. hand washbasins, showers, etc.) and, in some cases, also washing appliances (e.g. dishwashers). Moreover, such vehicles often have a grey water tank for storing grey water (that is to say waste water from washbasins and washing appliances), and it has already been suggested that grey water could also be reused as a flushing liquid, particularly for toilets, in order to reduce the required quantity of fresh water in the vehicles. Moreover, such vehicles often have a vacuum discharge system for sucking the flushing water out of the toilets and/or the grey water out of the grey water tank into a waste water tank by means of a vacuum in the waste water tank and in the respective waste water line, this being generated by a vacuum generator and/or low external air pressure in an air discharge line of the waste water tank. In the case of the proposed transfer of the grey water from the grey water tank to toilets as a flushing liquid, the grey water tank preferably contains a filter chamber in the tank housing in order to filter out contaminants in the grey water to ensure that the grey water is transferred to the toilets with only the minimum amount of contaminants. During a process of discharging the grey water from the grey water tank to the waste water tank by means of the vacuum discharge system, the contaminants that have been filtered out are then as far as possible also sucked out of the filter wall forming the filter chamber. Since, in practice, the grey water sometimes contains a large proportion and/or specific types of contaminants, the filter wall may even be at least partially blocked by the contaminants. In the case of previously proposed grey water tanks, it is generally not possible to clear such a blockage of the filter wall by means of the vacuum discharge system during the discharge process, and therefore the blockage produces a loss of functionality in the grey water tank, for which reason it may subsequently be necessary to carry out some other expensive cleaning process with the vehicle parked to enable the grey water to once again be transferred to the toilets as a flushing liquid in future.

### SUMMARY OF THE INVENTION

It is the object of the invention to provide an improved grey water tank and an improved grey water system which ensure more effective and more reliable cleaning of the grey water tank and especially also the filter wall thereof, in particular even in the case of a filter wall that is at least partially blocked by contaminants, and thus to avoid a loss of functionality in the grey water tank, even in the case of a high level of contamination of the grey water introduced.

This object is achieved by the subject matter of the invention, which is defined in the independent claims. A number of advantageous embodiments and further developments of the invention form the subject matter of the dependent claims.

The grey water tank according to the invention contains a tank housing having an internal space for holding grey water. The internal space being formed by a tank housing bottom, a tank housing top and a tank housing side wall extending between the tank housing bottom and the tank housing top. A filter wall is arranged inside the tank housing between the tank housing bottom and the tank housing top in such a way that there is an inner tank chamber within the filter wall and an outer tank chamber between the filter wall and the tank housing side wall. Adjacent to a first, lower, permeable filter wall portion, in its region facing the tank housing bottom, the filter wall has a second filter wall portion with a lower microbiological settlement capacity than the first filter wall portion. A fill level sensor system is provided for detecting a fill level of the tank housing with grey water. A connection is provided on the tank housing top in the region of the inner tank chamber for a grey water inlet line from at least one device that discharges grey water, in particular a washing device (e.g. hand washbasin, shower, dishwasher). A further connection is provided on the tank housing for a grey water transfer line to at least one device that uses flushing liquid, in particular a toilet. A connection is provided on the tank housing bottom in the region of the inner tank chamber, for a waste water line for discharging the grey water present in the tank housing by means of a vacuum discharge system. An air flow limiting element is arranged in the connection for the grey water inlet line. The element is configured to limit an air flow from the grey water inlet line into the inner tank chamber within the filter wall during a process of grey water discharge by means of the vacuum discharge system.

During the process of grey water discharge by means of the vacuum discharge system, the grey water is sucked out of the grey water tank by the vacuum in the vacuum discharge system, and the pressure in the inner tank chamber of the grey water tank is thereby also reduced, with the result that an air flow is sucked out of both the at least one device that discharges grey water and of the at least one device that uses the grey water as flushing liquid into the inner tank chamber and/or the outer tank chamber of the grey water tank and passed through the filter wall, as a result of which the contaminants are detached and then discharged together with the grey water. However, if the filter wall is at least partially blocked by contaminants, these air flows cannot simply flow through the filter wall in order to detach the contaminants. However, the air flow limiting element that is additionally installed according to the invention can limit (somewhat limit or even totally block) the air flow from the grey water inlet line into the inner tank chamber during the discharge process by means of the vacuum discharge system, thereby increasing the pressure difference between the inner tank chamber and the outer tank chamber because of the reduced volume in the inner tank chamber. Owing to this modified pressure ratio, the air flow from the grey water transfer line is drawn more powerfully from the outer tank chamber to the inner tank chamber, and can thus even flow through a blocked part of the filter wall. As a result, the contamination can thereby be more effectively detached from the filter wall and flushed into the outflowing grey water, making the cleaning of the filter wall very effective and ensuring that the grey water tank is more reliably functional for transfer of the not excessively contaminated grey water to the device that uses grey water as flushing liquid.

At worst, only very little or, at best, no contamination can adhere to the second filter wall portion since this filter wall portion has a lower microbiological settlement capacity than the first filter wall portion. Microbiological settlement capacity is taken to mean the ability of microbiological particles to settle on the filter wall, that is to say the ability of microorganisms and/or dirt particles to adhere to the filter wall. It is dependent, in particular, on the size of the settlement surface and on the material. At least on its surface, the second filter wall portion is formed from a material to which microorganisms and/or dirt particles can adhere very poorly or not at all. These are, in particular, materials with a smooth surface, which therefore have a small settlement surface and thus low settlement capacity. In particular, the material is impermeable to water, in particular grey water. The filter wall, in particular the second filter wall portion, is preferably manufactured from PTFE. The distance between a lower end of the second filter wall portion and an upper end of the second filter wall portion is, in particular, several centimeters. The area of the second filter wall portion as a proportion of the total area of the filter wall is preferably 10% to 90%, particularly preferably 20% to 80%. Since the contaminants are able to adhere primarily to a permeable filter wall portion, the filter wall is less contaminated overall, and therefore cleaning of the grey water tank and, in particular, of the filter wall thereof requires less effort and is thus more effective.

For the avoidance of doubt, it should be noted that the grey water tank contains the fill level sensor system in/on the tank housing because detection of the fill level is necessary in order to determine whether the quantity of grey water is sufficient as flushing liquid for the at least one connected device (in particular a toilet) or whether the grey water tank should be emptied. The vacuum discharge system serves, in particular, to drain the grey water tank (and also the toilet) but also to prevent overflowing of the grey water tank and to clean the filter wall in the grey water tank. Moreover, the vacuum discharge system is activated, in particular to remove water from the grey water tank, only if the connected washing devices and toilets are not being operated and are thus not active, and therefore, when the vacuum discharge system is active, after initial water removal only air instead of water is sucked into the grey water tank from these devices. The vacuum discharge system preferably has a flushing valve in the waste water line or at the connection thereof to the grey water tank.

In one embodiment of the invention, the air flow limiting element in the connection for the grey water inlet line is connected to a control unit which activates the air flow limiting element during the entire process of grey water discharge by means of the vacuum discharge system, in particular up to a predetermined limiting factor (e.g. full blocking or at least a high degree of blocking). Alternatively, in addition to the fill level sensor system, the grey water tank can furthermore have a filter block sensor system for detecting an at least partial blockage of the filter wall by contamination, and the air flow limiting element in the connection for the grey water inlet line can be connected to a control unit which activates the air flow limiting element (up to a predetermined limiting factor or variably according to filter block status) during the process of grey water discharge by means of the vacuum discharge system if the filter block sensor system detects an at least partial blockage of the filter wall. The filter block sensor system can, for example, have at least one sensor for direct detection of blockage, or can correspond to the fill level sensor system in order to infer a blockage from different fill levels in the inner tank chamber and the outer tank chamber. However, the first-mentioned variant without a filter block sensor system is more advantageous because there is less outlay on the production and control of the grey water tank. Even more preferably, the air flow limiting element in the connection for the grey water inlet line can be in the form of a flexible rubber lip, such that the air flow limitation takes place passively without the control unit.

In one embodiment of the invention, the grey water tank further contains at least one air inlet valve, which is arranged in the region of the outer tank chamber on the tank housing top or the tank housing side wall and is configured, when opened, to allow ambient air (e.g. from an aircraft cabin) to flow into the outer tank chamber. The air inlet valve is opened, in particular, during the process of grey water discharge by means of the vacuum discharge system to ensure that the ambient air flow, like the air flow from the grey water transfer line, is sucked from the outer tank chamber to the inner tank chamber and, in particular when the air flow limiting element at the inner tank chamber is activated, can even flow through a blocked part of the filter wall in addition to the air flow from the grey water transfer line. As a result, the contamination can thereby be detached more effectively or in a greater number of different filter wall portions from the filter wall and flushed into the outflowing grey water. The air inlet valve can optionally also be opened during the process of transferring the grey water to the toilet in order to achieve pressure equalization in the grey water tank and thereby to achieve foam reduction.

In one embodiment of the invention, the filter wall can furthermore additionally have, in its region facing the tank housing top, a third, upper, permeable filter wall portion adjacent to the second filter wall portion, since, right at the top, the filter wall can once again advantageously be permeable because grey water is only seldom present there and therefore virtually no contaminants adhere.

The filter wall, in particular the first filter wall portion and, where present, also the third filter wall portion, can be formed by a self-supporting filter material, which does not require a supporting structure. A material suitable for this purpose can be, for example, a metal mesh or a perforated metal surface. The filter wall preferably connects the tank housing bottom to the tank housing top.

The lower, permeable, first filter wall portion of the filter wall preferably corresponds to the region that is wetted most frequently by grey water (e.g. about 75-100% of the time), the upper, permeable, third filter wall portion of the filter wall corresponds to the region that is wetted only occasionally by grey water (e.g. about 0-25% of the time), and the second filter wall portion of the filter wall corresponds to the region that is wetted often by grey water (e.g. about 25-75% of the time). With such wetting of the individual filter wall portions, it is ensured that, overall, contamination of the filter wall is minimized since, for most of the time, the fill level of the grey water tank is in the region of the second filter wall portion, and this region has the smallest microbiological settlement capacity or settlement surface because the microbiological particles which could lead to contamination of the filter wall settle predominantly on the surface of the water. Corresponding control of the fill level is described below.

In one embodiment of the invention, the filter wall is mounted in a free support arrangement on the tank housing bottom and the tank housing top, making it freely movable relative to the tank housing (e.g. in a direction transverse to the tank housing side wall). Alternatively, the filter wall is of somewhat expandable or elastic configuration, at least in part. The air flow limiting element explained above gives rise during the vacuum discharge mode to large pressure ratios between the inner tank chamber and the outer tank chamber, with the result that the filter wall in this embodiment moves or varies mechanically, as a result of which, as the filter wall strikes against the edges of the support arrangement or during the flexible deformations, acceleration of the air flow is produced by the filter wall and the contaminants are thereby detached even more effectively. For example, the pressure ratios between the inner tank chamber and the outer tank chamber can for this purpose be amplified even further by a high on-off frequency of the vacuum discharge system, making the air throughflow and thus the cleaning even more effective.

In one embodiment of the invention, the filter wall has, in its region facing the tank housing bottom, a first permeable filter wall portion which is at least in part inclined outward in a direction toward the tank housing bottom and/or is of irregular shape. The inclination of the first filter wall portion and the irregular shape both produce a larger active filter surface and therefore enable the contaminants to fall even better into the water chamber part of the inner tank chamber below the filter chamber (referred to as a “sump”, for example).

As an option, the grey water tank furthermore comprises a connection for a fresh water inlet line from a fresh water tank, which is arranged on the tank housing top or the tank housing side wall in the region of the outer tank chamber. If the device (in particular a toilet) that uses flushing liquid is not provided directly with fresh water but only with reused grey water from the grey water tank, it is then also possible in this way to supply fresh water to the toilet via the grey water tank, especially if the grey water tank is too empty or if the grey water is too contaminated. The filter wall in the grey water tank also serves to protect the clean fresh water or the clean grey water/fresh water mixture for the toilet.

As an option, the grey water tank can furthermore comprise a connection, provided on the tank housing side wall, for a grey water discharge line for discharging the excess grey water in the tank housing, wherein a corresponding overflow valve is arranged in the grey water discharge line or optionally in the connection. Via this grey water discharge line, it is possible, e.g. in the case of an aircraft, to discharge grey water directly from the aircraft into the environment of the aircraft during flight (e.g. drain mast).

In one embodiment of the invention, the fill level sensor system has at least one first fill level sensor in the outer tank chamber and at least one second fill level sensor in the inner tank chamber. By means of the fill levels detected in the outer tank chamber and the inner tank chamber it is possible to determine the fill level of the grey water tank more reliably, and, by means of a difference between the fill levels in the outer tank chamber and the inner tank chamber, it is furthermore also possible to determine a blockage or a degree of blockage of the filter wall by contaminants.

To control the fill level of the grey water within the grey water tank, in particular to maintain the wetting of the second filter wall portion for 25-75% of the time, water can be introduced into the grey water tank as soon as the fill level falls below the lower end of the second filter wall portion. This can preferably be accomplished by introducing fresh water via the connection for the fresh water inlet line. The introduction of fresh water will continue, with control by means of the control unit, until the fill level has risen above the lower end of the second filter wall portion. Alternatively, additional grey water may also be fed to the grey water tank. For this purpose, the feed from the device that discharges grey water, in particular the washing device, is controlled in such a way by the control unit that the amount of grey water introduced into the grey water tank is such that the fill level in the grey water tank has risen above the lower end of the second filter wall portion. For this purpose, a fresh water feed element, e.g. a pump or a water tap, arranged between the fresh water tank and the device that discharges grey water is connected to the control unit.

Another possibility for controlling the fill level of the grey water within the grey water tank consists in connecting a pump arranged in the grey water transfer line by means of the control unit and in controlling the pump in such a way that it pumps enough grey water out of the grey water tank to ensure that the fill level of the grey water tank is in the region of the second filter wall portion. This further possibility for fill level control thus serves to impose an upper limit on the fill level.

According to a second aspect of the invention, the grey water system contains a grey water tank according to the invention, as described above, which is connected via a grey water inlet line to at least one device that discharges grey water, in particular a washing device (e.g. hand washbasin, shower, dishwasher); a vacuum discharge system for discharging the grey water from the grey water tank; at least one device, in particular a toilet, which uses flushing liquid and is connected via a grey water transfer line to the grey water tank; and a control unit for controlling the vacuum discharge system and the air limiting element in the connection for the grey water inlet line and the transfer of the grey water via the grey water transfer line, depending in each case on the fill level of the grey water tank. The same advantages are achieved with this grey water system as those explained above with reference to the grey water tank according to the invention.

Depending on the embodiment of the grey water tank according to the invention, the control unit is furthermore preferably configured to control (i) the at least one air inlet valve in the region of the outer tank chamber of the grey water tank and/or (ii) a valve in the connection to the fresh water inlet line for letting fresh water into the grey water tank and/or (iii) an overflow valve in the connection to the grey water discharge line or in the grey water discharge line for discharging the excess grey water in the tank housing.

In one embodiment of the invention, the at least one device (in particular a toilet) that uses flushing liquid and is connected to the grey water tank also has a connection for a waste water line for discharging the waste water by means of the vacuum discharge system, wherein the vacuum discharge system furthermore has a flushing valve in this waste water line or in this connection. Accordingly, the same vacuum discharge system, that is to say, in particular, the same waste water tank with the vacuum generator system connected thereto, is used for the grey water tank and for the toilet, wherein the waste water line of the toilet makes contact with the waste water line of the grey water tank or itself leads to the waste water tank.

The grey water tank according to the invention and the grey water system according to the invention can be used to particular advantage for aircraft and also for other vehicles (e.g. ships, trains).

Other features which are considered as characteristic for the invention are set forth in the appended claims.

Although the invention is illustrated and described herein as embodied in a grey water tank and a grey water system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a block diagram showing the construction of one exemplary embodiment of a grey water system according to the invention;

FIG. 2 is a sectional side view of one exemplary embodiment of the grey water tank according to the invention for a grey water system;

FIG. 3A is a sectional view of a state of the grey water tank in FIG. 2 during vacuum flushing without blocked first and third permeable filter wall portions of the filter wall;

FIG. 3B is a sectional view of the state of the grey water tank in FIG. 2 during vacuum flushing with blocked first and third permeable filter wall portions of the filter wall;

FIG. 3C is a sectional view of the state of the grey water tank in FIG. 2 during vacuum flushing with blocked first and third permeable filter wall portions of the filter wall and with the air flow limiting element activated;

FIG. 4A is a side view of the filter chamber in the grey water tank according to a first further variant embodiment according to the invention; and

FIG. 4B is a side view of the filter chamber in the grey water tank according to a second further variant embodiment according to the invention.

### DETAILED DESCRIPTION OF THE INVENTION

The below-explained exemplary embodiments of the grey water system and of the grey water tank can be used, in particular, in aircraft but also in other vehicles (e.g. ships, trains).

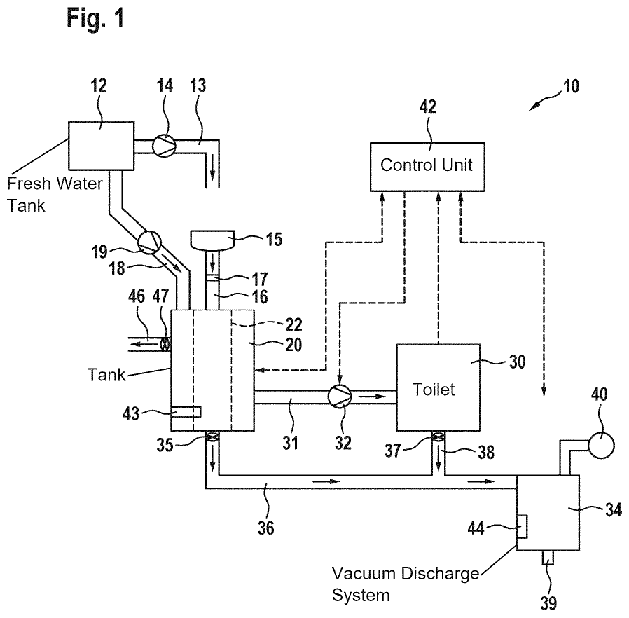

One exemplary embodiment of a grey water system according to the invention will now be explained with reference to FIG. 1.

The grey water system 10 contains a grey water tank 20 with a filter wall 22 for the formation of a filter chamber therein and with a fill level sensor system 43. The grey water tank 20 is connected via a grey water inlet line 16 to a washing device (e.g. hand washbasin) 15, which receives fresh water from a fresh water tank 12 via a fresh water line 13 by means of a pump 14 and discharges the fresh water used in washing as “grey water” to the grey water tank 10 via the grey water inlet line 16. As indicated in FIG. 1, a prefilter 17 can optionally be arranged in the grey water inlet line 16 to ensure that only grey water that has been cleaned to a certain degree is introduced into the grey water tank 20. Although only one washing device 15 that discharges grey water to the grey water tank 20 is shown in FIG. 1, the grey water tank 20 can optionally also be connected to a plurality of washing devices 16, the grey water inlet lines 16 of which can preferably be joined together, such that just one grey water inlet line element is coupled to the grey water tank 20. The construction and functioning of the grey water tank 20 are explained below in more concrete detail with reference to the further figures.

The grey water system 10 furthermore contains a toilet 30. Since, in this exemplary embodiment, the toilet 30 is not connected to a fresh water tank, it uses grey water as flushing liquid. However, the toilet 30 could optionally also be connected to a fresh water tank in order then to use either the fresh water from the fresh water tank or the grey water as flushing liquid, depending on the water volume ratios and water states. For the use of grey water as the flushing liquid, the toilet 30 is connected via a grey water transfer line 31 to the grey water tank 20, wherein a pump 32 for delivering the grey water is preferably arranged in the grey water transfer line 31. Although only a single toilet 30 is shown in FIG. 1, the grey water system 10 can also contain a number of toilets 30, wherein these can then all be connected via the grey water transfer line 31 to the grey water tank 20 in order to receive grey water as a flushing liquid from the grey water tank 20.

As indicated in FIG. 1, it is optionally also possible, in addition to the connection to the washing device 15 via the grey water inlet line 16, for the grey water tank 20 to be connected via a fresh water inlet line 18 to the fresh water tank 12 so that the grey water tank 20 can also receive a certain amount of fresh water, depending on the quantity and contamination of the grey water in the grey water tank 20. For this purpose, the fresh water inlet line 18 also contains a pump 19 for delivering the fresh water. In the exemplary embodiment of FIG. 1, the grey water tank 20 is connected to the same fresh water tank 20 as the washing device 15. If there is a plurality of fresh water tanks, the grey water tank 20 could alternatively also be connected to a different fresh water tank than the washing device 15.

The grey water system 10 furthermore contains a vacuum discharge system 34-40, which is connected to the grey water tank 20 in order to discharge grey water from the grey water tank 20. In the exemplary embodiment of FIG. 1, the toilet 30 is connected to the same vacuum discharge system 34-40 for discharging the flushing water. As indicated in FIG. 1, the vacuum discharge system 34-40 contains a waste water tank 34 for receiving the discharged grey water and flushing water, which also contains a waste water outlet 39 and a fill level sensor system 44, a waste water line 36 for connecting the grey water tank 20 to the water tank 34, a flushing valve 35 (preferably in the waste water line 36 close to the grey water tank 20) for activating grey water discharge from the grey water tank, a waste water line 38 for connecting the toilet 30 to the water tank 34, wherein the waste water line 38 is coupled in this exemplary embodiment to the other waste water line 36, a flushing valve 37 (preferably in the waste water line 38 close to the toilet 30 for the purpose of activating flushing water discharge from the toilet), and a vacuum generator system 40 (usually with an exhaust air pipe leading to the vehicle exterior and with a vacuum generator) for generating a vacuum in the waste water lines 36, 38 and in the waste water tank 34 for the purpose of sucking the grey water out of the grey water tank 20 and the flushing water out of the toilet 30. Such a vacuum discharge system 34-40 is known in principle to those skilled in the art, for which reason detailed explanations of the construction and functioning of the vacuum discharge system can be dispensed with. In the grey water system 10 according to the invention, any functional variant embodiments of the vacuum discharge system can be used in principle.

As illustrated in FIG. 1, the grey water tank 20 is optionally also connected to a grey water discharge line 46, wherein an overflow valve 47 for activation is arranged in the grey water discharge line 46 or on the grey water tank 20. Via the grey water discharge line 46, it is possible in particular to discharge an excess of grey water out of the grey water tank 20, wherein the grey water can be discharged from the respective vehicle, in particular an aircraft, during driving (or flight) directly into the aircraft environment via this grey water line 46.

The grey water system 10 also includes a control unit 42. As indicated to a small extent in FIG. 1, the control unit 42 is used to control the grey water tank 20 (as explained in more concrete detail below with reference to the other figures), the pump 32 for transferring the grey water from the grey water tank 20 to the toilet 30, and the vacuum discharge system 34-40. For these control operations, the control unit 42 receives relevant parameter data on the elements of the grey water system 10, in particular the fill level of the grey water tank 20 (in order to ascertain whether the grey water quantity in the grey water tank 20 is sufficient for the transfer of grey water as flushing liquid to the toilet 30 and whether emptying of the grey water tank 20 should take place), the activity of the toilet 30 (in order to ascertain whether grey water should be transferred as flushing liquid to the toilet 30), non-usage and thus inactivity of the washing device 15 and of the toilet 30 (in order to ascertain whether emptying of the grey water tank 20 can be carried out by means of the vacuum discharge system 34-40, because in that case only air, instead of water, should be sucked into the grey water tank 20 from these devices 15, 30, wherein the emptying of the grey water tank 20 by the vacuum discharge system 34-40 can also be carried out when the washing device 15 is active), and the fill level of the waste water tank 34 (in order to ascertain whether the vacuum discharge system can still be activated).

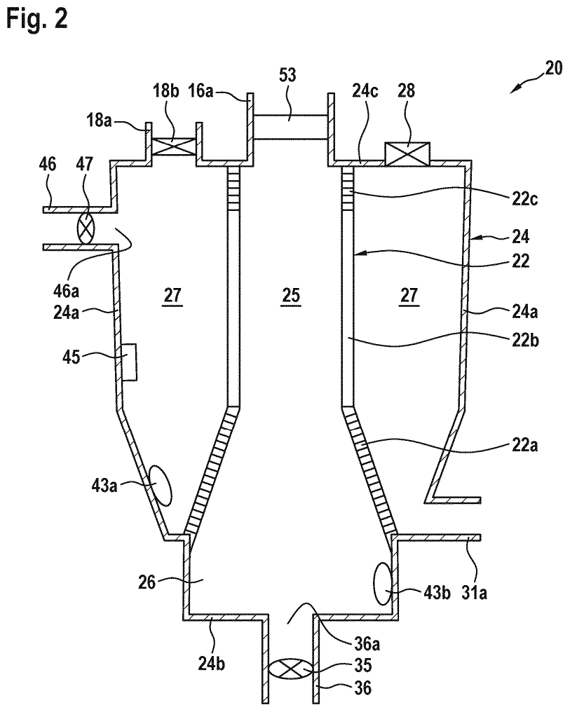

Referring to FIG. 2, a specific exemplary embodiment of a grey water tank 20 according to the invention for the grey water system 10 explained above will now be explained in greater detail.

The grey water tank 20 has a tank housing 24, which is formed by a tank housing side wall 24a, a tank housing bottom 24b and a tank housing top 24c, wherein the tank housing side wall 24a extends between the tank housing bottom 24b and the tank housing top 24c, and the tank housing 24 thus formed forms an internal space for holding grey water. The tank housing 24 is of substantially cylindrical shape over the majority of its longitudinal direction (top to bottom direction in FIG. 2), wherein the cylindrical shape can have a substantially circular, square or polygonal cross-sectional shape, for example. Arranged within the tank housing 24 is a filter wall 22 for the formation of a filter chamber. The filter wall 22 extends between the tank housing bottom 24b and the tank housing top 24c in such a way that, on the one hand, there is an inner tank chamber 25 within the filter wall 22 and, on the other hand, there is an outer tank chamber 27 between the filter wall 22 and the tank housing side wall 24a. In the region of the inner tank wall 25, the tank housing bottom 26 is recessed somewhat, thereby giving rise to a water chamber part 26 (sometimes referred to as a “sump”) below the filter wall 22 for the discharge of the grey water to the waste water tank 34.

As illustrated in FIG. 2, the filter wall 22 has a first, lower, permeable filter wall portion 22a facing the tank housing bottom 24b, a second impermeable filter wall portion 22b adjacent to this first, lower, permeable filter portion 22a, and a third, upper, permeable filter wall portion 22c facing the tank housing top 24c. The permeable filter wall portions 22a, 22c filter contaminants out of the grey water, which then remain stuck in these permeable filter wall portions 22a, 22c, in particular when the grey water flows between the inner tank chamber 25 and the outer tank chamber 27. In this way, the grey water is transferred to the toilet 30 as far as possible without contaminants. However, it may be that no contamination or, at worst, only very little contamination sticks to the second impermeable filter wall portion 22b. The second filter wall portion 22b namely has a smaller microbiological settlement surface than the first filter wall portion 22a and also, in this exemplary embodiment, than the third filter wall portion 22c. This is achieved, on the one hand, by means of the impermeable configuration of the second filter wall portion. On the other hand, the second impermeable filter wall portion 22b of the filter wall 22 is preferably also made of a material to which microorganisms adhere poorly or not at all (e.g. PTFE). In this exemplary embodiment, the first, lower, permeable filter wall portion 22a of the filter wall 22 is preferably inclined at least in part outward and downward toward the tank housing bottom 24b, thereby giving rise to a somewhat larger active filter surface than in the case of a vertical first, lower, permeable filter wall portion 22a, and this conveys the contamination of the grey water even more effectively into the lower water chamber part (“sump”) 26 of the inner tank chamber 25. Although not illustrated, the first, lower, permeable filter wall portion 22a of the filter wall 22 can alternatively or additionally be of irregular shape, thereby likewise giving rise to a larger active filter surface.

The first, lower, permeable filter wall portion 22a of the filter wall 22 extends over the region that is wetted most frequently by grey water (e.g. about 75-100% of the time), the third, upper, permeable filter wall portion 22c of the filter wall 22 extends over the region that is wetted only occasionally by grey water (e.g. about 0-25% of the time), and the second impermeable filter wall portion 22b of the filter wall 22 corresponds to the region that is wetted often by grey water (e.g. about 25-75% of the time).

Arranged on the tank housing bottom 24b in the lower water chamber part 26 is a connection 36a for the waste water line 36, through which grey water can be sucked out of the grey water tank 20 by means of the vacuum discharge system 34-40 when the flushing valve 35 opens the coupling to the waste water line 36 during the discharge process. In this exemplary embodiment, the flushing valve 35 is arranged in the waste water line 36; alternatively, the flushing valve 35 could also be arranged in the connection 36a on the grey water tank 20.

A connection 16a for the grey water inlet line 16 from the at least one washing device 15 is provided on the tank housing top 24c in the region of the inner tank chamber 25. An air flow limiting element 53 is furthermore arranged in this connection 16a for the grey water inlet line 16. The air flow limiting element 53 is in the form of a flexible rubber lip, for example, and therefore brings about limitation of the air flow into the grey water tank 20 during the process of grey water discharge. On the other hand, the air flow limiting element 53 may also be configured to be activated during the process of grey water discharge by means of the vacuum discharge system 34-40 and thereby to limit or completely block air flow from the grey water inlet line 16 into the inner tank chamber 25. In this case, the air flow limiting element 53 is controlled by the control unit 42 of the grey water system 10, preferably automatically to a predetermined limitation factor during the entire process of grey water discharge by means of the vacuum discharge system. As indicated in FIG. 2, the grey water tank 20 may optionally also have a filter block sensor system 45 for detecting an at least partial blockage of the filter wall 22 by contamination, the detected parameter data of which are supplied to the control unit 42, such that the control unit 42 then optionally only activates the air flow limiting element 53 in the connection 16a for the grey water inlet line 16 during the process of grey water discharge by means of the vacuum discharge system 34-40 (to a predetermined limitation factor or variably depending on the filter block status) if the filter block sensor system 45 detects an at least partial blockage of the filter wall 22. The filter block sensor system 45 contains, for example, at least one sensor for direct detection of the blockage of the filter wall 22.

A connection 31a for the grey water transfer line 31 to the at least one toilet 30 is arranged on the tank housing 22 in the region of the first, lower, permeable filter wall portion 22a of the filter wall 22, e.g. on the tank housing side wall 24a or the tank housing bottom 24b.

An air inlet valve 28 is furthermore preferably arranged on the tank housing top 24c in the region of the outer tank chamber 27. The air inlet valve 28 can be controlled by the control unit 42 during the process of grey water discharge by means of the vacuum discharge system 34-40 in order to be opened to allow ambient air, e.g. from an aircraft cabin, to flow into the outer tank chamber 27 of the grey water tank 20. As an option, this air inlet valve 28 can also be opened during the process of transferring the grey water to the toilet 30.

Since the grey water tank 20 is also connected to a fresh water tank 12 in the exemplary embodiment in FIG. 1, a connection 18a for the fresh water inlet line 18 from the fresh water tank 12 is furthermore arranged on the tank housing top 24c (or alternatively on the tank housing side wall 24a close to the tank housing top 24c) in the region of the outer tank chamber 27. The filter wall 22 also serves to protect the clean fresh water or the clean grey water/fresh water mixture for the toilet 30. A valve 18b is optionally also arranged in this connection 18a for the fresh water inlet line 18, which valve can be closed by the control unit 42 during the process of grey water discharge by means of the vacuum discharge system 34-40 in order to prevent inflow of fresh water into the grey water tank 20 during the process of grey water discharge.

A connection 46a is furthermore optionally provided in the upper region on the tank housing side wall 24a, through which connection excess grey water in the tank housing 22 can be discharged. A grey water discharge line 46 is then connected to this connection 46a (as illustrated in FIG. 1), through which discharge line at least some of the large volume of grey water can be discharged into the aircraft environment directly from the aircraft while it is still in flight. In this exemplary embodiment, a flushing valve 47 for opening the coupling of the connection 46a to the grey water discharge line 46 is arranged in the grey water discharge line 46, wherein the flushing valve 47 could alternatively also be arranged in the connection 46a on the grey water tank 20.

As indicated in FIG. 2, the fill level sensor system 43 for detecting a fill level of the tank housing 24 with grey water preferably has a first fill level sensor 43a in the outer tank chamber 27 and a second fill level sensor 43b in the inner tank chamber 25 (e.g. in the region of the lower water chamber part 26). The parameter data detected by the fill level sensor system 43 are supplied to the control unit 42 of the grey water system 10 in order to control the transfer of grey water to the toilet 30 and the discharge of grey water by means of the vacuum discharge system 34-40 as well as, where applicable, the introduction of fresh water into the grey water tank 20 in accordance with the existing quantity of grey water in the grey water tank 20. If at least two fill level sensors 43a, 43b are used in different chambers 25, 27 of the grey water tank 20, the fill level of the grey water tank 20 can be reliably determined and it is furthermore also possible, on the basis of a difference between the fill levels in the outer tank chamber 27 and in the inner tank chamber 25, to detect a blockage or a degree of blockage of the filter wall 22 by contaminants.

The exemplary embodiment in FIG. 2 furthermore shows an optional modification of the grey water tank 20 according to the invention, such that the tank housing side wall 24a is inclined inward and in a downward direction toward the tank housing bottom 24b in the lower end region of the filter wall 22. As a consequence, there is a large change in volume, even in the case of a small change in the fill level of the grey water in the grey water tank 20, as a result of which the region of the first, lower, permeable filter wall portion 22a of the filter wall 22 is wetted fully more quickly, this being advantageous for the potential transfer of the grey water to the toilet 30.

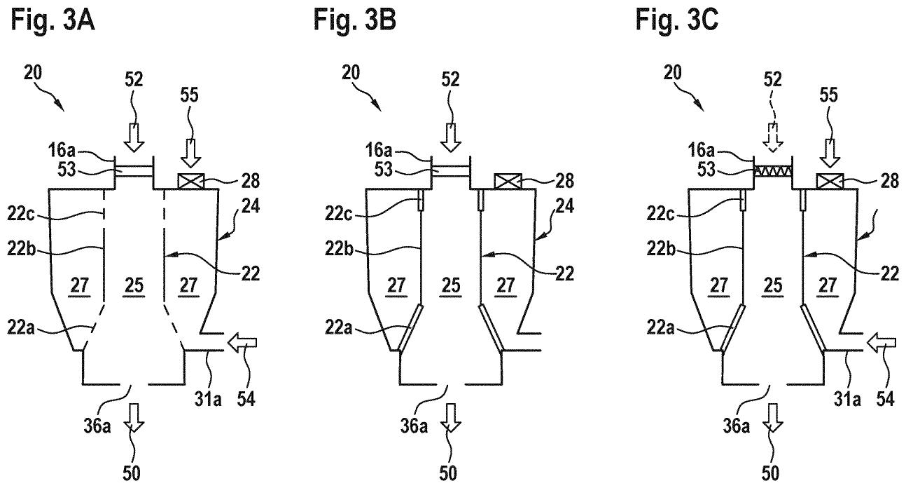

Referring to FIGS. 3A, 3B, 3C, the cleaning effectiveness of the grey water tank 20 according to the invention on the basis of the air flow limiting element 53 will now be explained.

FIG. 3A shows a state of the grey water tank 20 in which the permeable filter wall portions 22a, 22c of the filter wall are not blocked by contaminants. When the vacuum discharge system 34-40 for the process of grey water discharge from the grey water tank 20 is activated, the connection 36a to the waste water line 36 is coupled by the opening of the flushing valve 35 in order to suck the grey water, together with its contaminants, out of the grey water tank 20 (grey water flow 50) by means of the vacuum in the waste water line 36 and the waste water tank 34. This extraction of the grey water from the grey water tank 20 also gives rise to a lower pressure state in the tank housing 24, with the result that, when the air flow limiting element 53 is not activated, an air flow 52 is sucked through the connection 16a into the tank housing 24 from the inoperative washing device 15, an air flow 54 is sucked from the inactive toilet 30, through the connection 31a, into the outer tank chamber 27 and onward through the first, lower, permeable filter wall portion 22a into the inner tank chamber 25, and an ambient air flow 55 is sucked through the opened air inlet valve 28 into the outer tank chamber 27 and onward through the third, upper, permeable filter wall portion 22c and also through the first, lower, permeable filter wall portion 22a into the inner tank chamber 25. By means of these air flows 52, 54, 56, the inner tank chamber 25 and the outer tank chamber 27 of the tank housing 24 and also the filter wall 22 are freed from contaminants contained or adhering therein, and these are then discharged together with the grey water, resulting in cleaning of the tank housing 24 and of the filter wall 22.

FIG. 3B shows a state of the grey water tank 20 in which the permeable filter wall portions 22a, 22c of the filter wall are blocked by contaminants in the case of an air flow limiting element 53 which is not activated or not present, that is to say as per conventional grey water tanks. When the vacuum discharge system 34-40 for the process of grey water discharge from the grey water tank 20 is activated, the connection 36a to the waste water line 36 is coupled by the opening of the flushing valve 35 in order to suck the grey water, together with its contaminants, out of the grey water tank 20 (grey water flow 50) by means of the vacuum in the waste water line 36 and the waste water tank 34. This extraction of the grey water from the grey water tank 20 gives rise to a lower pressure state at least in the inner tank chamber 25 of the tank housing 24, with the result that, when the air flow limiting element 53 is not activated or not present, an air flow 52 is sucked through the connection 16a into the tank housing 24 from the inoperative washing device 15. Owing to the blocked permeable filter wall portions 22a, 22c, however, the pressure in the outer tank chamber 27 is reduced only very slightly or not at all, and therefore no air flow at all is sucked into the outer tank chamber 27 and, in particular, also no air flow is sucked through the permeable filter wall portions 22a, 22c into the inner tank chamber 25, either from the inactive toilet 30 or through the opened air inlet valve 28. On account of the fact that the air flows 54, 56 do not form, the outer tank chamber 27 and, in particular, the blocked filter wall portions 22a, 22c of the filter wall 22 cannot be freed from the contaminants contained or adhering therein, these then being discharged together with the grey water, and therefore effective cleaning of the tank housing 24 and of the filter wall 22 is not possible.

FIG. 3C shows a state of the grey water tank 20 in which the permeable filter wall portions 22a, 22c of the filter wall are blocked by contaminants in the case of an air flow limiting element 53 which is activated, that is to say as per the grey water tank 20 according to the invention. When the vacuum discharge system 34-40 for the process of grey water discharge from the grey water tank 20 is activated, the connection 36a to the waste water line 36 is coupled by the opening of the flushing valve 35 in order to suck the grey water, together with its contaminants, out of the grey water tank 20 (grey water flow 50) by means of the vacuum in the waste water line 36 and the waste water tank 34. This extraction of the grey water from the grey water tank 20 gives rise to a lower pressure state at least in the inner tank chamber 25 of the tank housing 24. Since, according to the invention, the air flow limiting element 53 in the connection 16a for the grey water inlet line 16 is activated or is self-acting, no air flow 52 at all or a very low air flow 52a is sucked through the connection 16a into the inner tank chamber 25 of the tank housing 24 from the inoperative washing device 15. Owing to the albeit very low air flow 52a into the inner tank chamber 25, the pressure in the inner tank chamber 25 is significantly lower than in the conventional state shown in FIG. 3B, and therefore, with respect to the outer tank chamber 27, in which the pressure is only very slightly reduced or not reduced on account of the blocked permeable filter wall portions 22a, 22c, at least a large pressure difference arises between the inner tank chamber 25 and the outer tank chamber 27. Owing to this modified pressure ratio, the air flow 54 from the grey water transfer line 31 and the recirculating air flow 55 through the air inlet valve 28 is drawn more powerfully from the outer tank chamber 27 to the inner tank chamber 25, and can thus even flow through the blocked filter wall portions 22a, 22c of the filter wall 22. Consequently, the use of the air flow limiting element 53 according to the invention makes it possible, even when the filter wall portions 22a, 22c are blocked by contamination, to release the contamination from the impermeable filter wall portion 22b and out of the permeable filter wall portions 22a, 22c of the filter wall and flush it into the outflowing grey water. Cleaning of the filter wall 22 is thus possible and very effective, even when there is severe contamination of the grey water tank 20, which is fundamentally possible in practice, and therefore the grey water tank 20 according to the invention is more reliably functional for the transfer of grey water that is not too dirty as flushing liquid to the toilet 30.

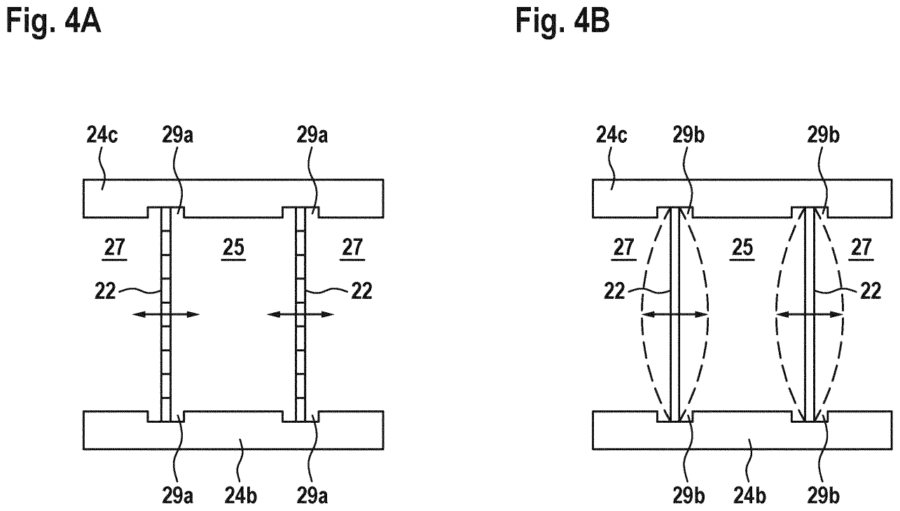

Referring to FIGS. 4A and 4B, special embodiments of the filter wall 22 for the grey water tank 20 according to the invention will now be explained.

FIG. 4A shows an optional modified embodiment of the grey water tank 20 according to the invention. As illustrated in FIG. 4A, the filter wall 22 is mounted in a free support arrangement 29a both on the tank housing bottom 24b and on the tank housing top 24c, making it somewhat movable relative to the tank housing 24, e.g. in a direction transverse to the tank housing side wall 24a. By virtue of the action, explained above with reference to FIG. 3C, of the air flow limiting element 53 in the connection 16a for the grey water inlet line 16, large pressure ratios arise between the inner tank chamber 25 and the outer tank chamber 27, and therefore the filter wall 22 in this embodiment moves to a certain extent in a direction transverse to the tank housing side wall 24a (as indicated by the two right-left arrows). As a consequence of this, the filter wall 22 strikes against the edges of the support arrangement 29a, as a result of which an acceleration of the respective air flow 54, 55 is produced by the filter wall 22 and the contaminants can thereby be detached even more effectively from the permeable filter wall portions 22a, 22c of the filter wall 22. In this context, the pressure ratios between the inner tank chamber 25 and the outer tank chamber 27 can optionally be amplified even further by a high on-off frequency of the vacuum discharge system 34-40, making the air throughflow and thus the cleaning even more effective.

FIG. 4B shows an alternative optional modified embodiment of the grey water tank 20 according to the invention. As illustrated in FIG. 4B, the filter wall 22 is mounted in a narrow support arrangement 29b both on the tank housing bottom 24b and on the tank housing top 24c, and is additionally of somewhat expandable or elastic configuration, at least in part. By virtue of the action, explained above with reference to FIG. 3C, of the air flow limiting element 53 in the connection 16a for the grey water inlet line 16, large pressure ratios arise between the inner tank chamber 25 and the outer tank chamber 27 in the vacuum discharge mode, and therefore the filter wall 22 in this embodiment moves or varies mechanically to a certain extent (as indicated by the two right-left arrows). As a consequence of this, the filter wall 22 is deformed flexibly, as a result of which an acceleration of the respective air flow 54, 55 is produced by the filter wall 22 and the contaminants can thereby be detached even more effectively from the permeable filter wall portions 22a, 22c of the filter wall 22. In this context too, the pressure ratios between the inner tank chamber 25 and the outer tank chamber 27 can optionally be amplified even further by a high on-off frequency of the vacuum discharge system 34-40, making the air throughflow and thus the cleaning even more effective.

The invention is also defined by the dependent claims. The exemplary embodiments explained above serve only for a better understanding of the invention but are not intended to restrict the scope of protection defined by the claims. As is apparent to a person skilled in the art, other embodiments are possible within the scope of the invention, in particular by omitting individual features from or adding additional features to the exemplary embodiments described above and by other combinations of features of exemplary embodiments explained above.

The following is a summary list of reference numerals and the corresponding structure used in the above description of the invention:
10 grey water system
12 fresh water tank
13 fresh water line from 12 to 15
14 pump in 13
15 device discharging grey water (in particular washing device)
16 grey water inlet line from 15 into 20
16a connection for 16 to 24c and 25
17 prefilter in 16
18 fresh water inlet line from 12 into 20
18a connection for 18 to 24c and 27
18b valve in connection 18a
19 pump in 18
20 grey water tank
22 filter wall
22a first filter wall portion of the filter wall
22b second filter wall portion of the filter wall
22c third filter wall portion of the filter wall
24 tank housing
24a tank housing side wall
24b tank housing bottom
24c tank housing top
25 inner tank chamber within the filter wall
26 water chamber part of the inner tank chamber below the filter chamber
27 outer tank chamber between the filter wall and the tank housing side wall
28 air inlet valve into 24 and 27
29a free support of the filter wall in 24b, 24c
29b narrow support of the filter wall in 24b, 24c
30 device (in particular toilet) that uses flushing liquid
31 grey water transfer line from 20 to 30
31a connection for 31 to 24a
32 pump in 31
34-40 vacuum discharge system
34 waste water tank
35 flushing valve for grey water tank to 36, 34
36 waste water line from 20 to 34
36a connection for 36 to 24b
37 flushing valve for 30 to 38
38 waste water line from 30 to 34
39 waste water outlet
40 vacuum generator system for vacuum in 34, 36, 38 for waste water extraction
42 control unit
43 fill level sensor system in/on grey water tank
43a first fill level sensor in 27
43b second fill level sensor in 25
44 fill level sensor system in/on waste water tank
45 filter block sensor system
46 grey water outlet line for overflow
46a connection for 46 to 24a
47 overflow valve of the grey water tank on 24a to 46
50 grey water flow from 20 to 34
52 air flow from 15 into 20
52a limited air flow from 15 into 20
53 air flow limiting element in 16a
54 air flow from 30 into 20
55 ambient air flow into 20

1. A grey water tank, comprising:
a tank housing having an internal space for holding grey water, said tank housing having a tank housing bottom, a tank housing top and a tank housing side wall extending between said tank housing bottom and said tank housing top for defining said internal space;
a filter wall disposed inside said tank housing between said tank housing bottom and said tank housing top such that there is an inner tank chamber within said filter wall and an outer tank chamber between said filter wall and said tank housing side wall, wherein said filter wall has a first, lower, permeable filter wall portion and a second filter wall portion, wherein adjacent to said first, lower, permeable filter wall portion, in a region facing said tank housing bottom, said filter wall has said second filter wall portion with a lower microbiological settlement capacity than said first filter wall portion;
a fill level sensor system for detecting a fill level of said tank housing holding the grey water;
a first connection, disposed on said tank housing top in a region of said inner tank chamber, for connecting to a grey water inlet line from at least one device that discharges the grey water;
a second connection, disposed on said tank housing, for connecting to a grey water transfer line connected to at least one further device that uses a flushing liquid;
a third connection, disposed on said tank housing bottom in a region of said inner tank chamber, for connecting to a waste water line for discharging the grey water present in said tank housing by means of a vacuum discharge system; and
an air flow limiting element disposed in said first connection for the grey water inlet line, said air flow limiting element configured to limit an air flow from the grey water inlet line into said inner tank chamber within said filter wall during a process of grey water discharge by means of the vacuum discharge system.

2. The grey water tank according to claim 1,
further comprising a controller, said flow limiting element in said first connection for the grey water inlet line is connected to said controller which activates said air flow limiting element during an entirety of said process of grey water discharge by means of the vacuum discharge system; or
wherein said grey water tank furthermore has a filter block sensor system for detecting an at least partial blockage of said filter wall by contamination, and said air flow limiting element in said first connection for the grey water inlet line is connected to said controller which activates said air flow limiting element during the process of grey water discharge by means of the vacuum discharge system if said filter block sensor system detects an at least partial blockage of said filter wall; or
wherein said air flow limiting element in said first connection for the grey water inlet line is a flexible rubber lip, such that the air flow limitation takes place passively without said controller.

3. The grey water tank according to claim 1, further comprising at least one air inlet valve disposed in a region of said outer tank chamber on said tank housing top or said tank housing side wall and is configured, when opened, to allow ambient air to flow into said outer tank chamber.

4. The grey water tank according to claim 1, wherein said filter wall furthermore has, in a region facing said tank housing top, a third, upper, permeable filter wall portion adjacent to said second filter wall portion.

5. The grey water tank according to claim 4, wherein:
said first, lower, permeable filter wall portion of said filter wall corresponds to a region that is wetted most frequently by the grey water;
said third filter wall portion of said filter wall corresponds to a region that is wetted only occasionally by the grey water; and
said second filter wall portion of said filter wall corresponds to a region that is wetted often by the grey water.

6. The grey water tank according to claim 1, wherein said tank housing bottom and said tank housing top together define a free support arrangement, said filter wall is mounted in said free support arrangement formed on said tank housing bottom and on said tank housing top, making it freely movable relative to said tank housing.

7. The grey water tank according to claim 1, wherein said filter wall is an expandable configuration, at least in part.

8. The grey water tank according to claim 1, wherein said filter wall has, in a region facing said tank housing bottom, said first, lower permeable filter wall portion which is at least in part inclined outward in a direction toward said tank housing bottom and/or is of irregular shape.

9. The grey water tank according to claim 1, further comprising a fourth connection for connecting to a fresh water inlet line leading to a fresh water tank, said fourth connection disposed on said tank housing top or said tank housing side wall in a region of said outer tank chamber.

10. The grey water tank according to claim 9, further comprising a fifth connection, disposed on said tank housing side wall, for connecting to a grey water discharge line for discharging excess said grey water in said tank housing.

11. The grey water tank according to claim 1, wherein said fill level sensor system has a first fill level sensor in said outer tank chamber and a second fill level sensor in said inner tank chamber.

12. A grey water system, comprising:
a grey water inlet line;
at least one device;
said grey water tank according to claim 10, said grey water tank connected via said grey water inlet line to said at least one device that discharges grey water;
a vacuum discharge system for discharging the grey water from said grey water tank;
a grey water transfer line;
at least one further device which uses the flushing liquid and is connected via said grey water transfer line to said grey water tank; and
a controller for controlling said vacuum discharge system and said air limiting element in said first connection for said grey water inlet line and a transfer of the grey water via said grey water transfer line, depending in each case on the fill level of said grey water tank.

13. The grey water system according to claim 12,
wherein said grey water tank has a valve disposed in said fourth connection;
further comprising a fresh water inlet line connected to said fourth connection;
further comprising an overflow valve disposed in said fifth connection;
further comprising a grey water discharge line connected to said fifth connection;
wherein said controller is furthermore configured to control said at least one air inlet valve in the region of said outer tank chamber of said grey water tank and/or said valve in said fourth connection connected to said fresh water inlet line for letting fresh water into said grey water tank and/or said overflow valve in said fifth connection connected to said grey water discharge line or in said grey water discharge line for discharging excess said grey water in said tank housing.

14. The grey water system according to claim 12,
further comprising a waste water line; and
wherein said at least one further device that uses the flushing liquid and is connected to said grey water tank also has a connection connected to said waste water line for discharging the waste water by means of said vacuum discharge system.
